(19) United States
(12) Patent Application Publication
(10) Pub. No.: US 2026/0021886 A1
(43) Pub. Date: Jan. 22, 2026

(54) Skyrider

(71) Applicant: Srdjan Jovanovic, Barriere (CA)

(72) Inventor: Srdjan Jovanovic, Barriere (CA)

(21) Appl. No.: 18/831,107

(22) Filed: Jul. 16, 2024

(51) Int. Cl. B64C 39/00

(52) U.S. Cl. CPC B64C 39/00

(57) ABSTRACT

Skyrider includes a body, seating area, control panel, battery and multiple power packs that consist of electric motors and vertically, eccentrically rotated arms with weights. Centrifugal forces created, provide an uplift force and directional control to the vehicle.

### BACKGROUND

The present disclosure pertains to vehicle put in motion by one or multiple orbital rotating power packs with multiple rotating weighs and utilizing a vertically created centrifugal force to produce vehicle uplift.

To date there are only several systems used to enable humans to fly and most of them were invented in early twentieth century, remaining unchanged to present date.

Currently used are following propulsion systems
Hot air balloon
Rocket (action and reaction)
Jet engine (action and reaction)
Propeller (vertically or horizontally positioned)
Wing (typically combined with propeller or jet engine action)

Each of the propulsion systems mentioned above have its own positive and negative sides, however all (except hot air balloon) are producing air disturbance around the vehicle and are required to be operated by highly trained operators, ground staff, high operating costs and inability to provide mass usage of air space for daily commutes by ordinary people-short and long, similar to what current motor vehicle provide but on the ground.

### DETAILED DESCRIPTION

### Item #1

Typically, when thinking of centrifugal force, systems are typically required to be balanced. For decades we have been trying to achieve perfect balance of rotating systems to minimize impact of centrifugal force. Idea of this patent application is to harness the centrifugal force in a following manner: if weights are created to rotate in vertical plain with axes of rotation off center, force created will be greater at the position where weights are further of the axes (upper position) vs. one on the opposite side that is closer to the axes (lower position). This different in forces would create a positive uplifting force that could be utilized to overcome gravity. Assembly like that in future description will be referred to as a “power pack”.

### Item #2

By having only two opposed arms, maximum uplift force would be created when one arm is in far upper position (furthest from the axes of rotation) vs the opposed one in lower position (closest to axes of rotation). Action like this is possible, however force produced would intermittent and impractical for use. By adding multiple arms, force produced becomes more uniform and continuous which is required for producing practical uplifting force and enabling powering of the vehicle.

### Item #3.

Power train assemblies on the modern vehicles could have thousands of moving parts and quite complicated designs to achieve performances.

Power pack's compact design provides efficiency and simplicity, while providing performance with less than 100 parts per each assembly.

### Item #4

To achieve proper stability of the vehicle, typically multiple power packs are required. Size, capacity and number of power packs is determined by vehicle's specifications (lifting capacity, speed . . . , etc).

### Item #5.

Vehicle cabin and body assembly is designed to provide maximum comfort, security while housing all power and control systems required for vehicle operation

### Item #6

Vehicle directional control is achieved by applying different power and changing RPM's on each individual power pack, which will be explained below.

### Item #7

Vehicle power source could be any source of electrical power for electric motors, however current design is based on battery powered power packs.

### BRIEF SUMMARY OF INVENTION

Use of centrifugal force to produce uplift/horizontal force used to power the vehicle

### Detailed Summary of Invention

In one respect, the subject matter described herein is directed to vehicle body powered with single or multiple centrifugal rotating power packs, described in detail further below, that provide positive vertical uplift force. When rotating plain is strictly vertical, only uplift force is created for vehicle vertical movement. When rotating plain is tilted combination of vertical and horizontal force is created which is utilized for vehicle uplift and forward/backward movement. Vehicle control (up and down, only) is achieved by increasing RPM of each power pack simultaneously and for the same amount.

Vehicle control (forward and backward) is achieved by increasing/decreasing RPM on front/back set of power packs. For forward motion front power packs will run at lower RPM than back ones, creating slight tilt in vehicle position towards forward, which would create horizontal component of the force and propel vehicle forward. Same but opposite would be done for backward motion.

Vehicle control (left and right) is achieved by increasing/decreasing RPM on left/right set of power packs. To turn right, left power packs would run at higher RPM than right ones to achieve this movement. Same but opposite would be done for the turn to the left.

### DRAWINGS BRIEF DESCRIPTION

FIG. 1—Top view of the vehicle showing approximate location of four power packs (different arrangements and number of power packs is possible depending on vehicle lifting capacity/speed requirements)

FIG. 2—Side view of the vehicle showing approximate shape, cabin and location of power packs looked from the side

FIG. 3—Top view of the vehicle with approximate arrangement of the cabin

FIG. 4—Shows top view of the power pack assembly with braces.

FIG. 5—Shows side view of power pack assembly with braces

FIG. 6—Shows vertical cross section through power pack assembly

FIG. 7—Shows power control and distribution to independent power packs

FIG. 8—Shows vertical cross section through power pack

### VEHICLE COMPONENT LIST (AS SHOWN ON THE DRAWINGS)

1. Vehicle body.
2. Chasses
3. Power pack (typ. for 4 as shown on attached arrangement—it could vary)
4. Seats
5. Battery
6. Dash and controller
7. Lights and signaling
8. Extendable arms of the power pack
9. Bearing connector, block and weight
10. Bearings
11. Main shaft.
12. Pillow block bearings
13. Electric motor with VFD
14. Power transmission (pullies and belts, chain and sprockets or direct drive)
15. Hub
16. Two-part housing enclosure
17. Cap/connector
18. Inner bearing track
19. Outer bearing track
20. Reinforcing ribs
21. Power pack mounting plate

### DRAWINGS DETAILED DESCRIPTION

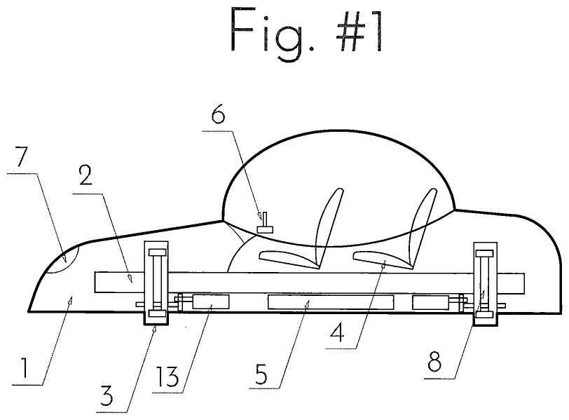

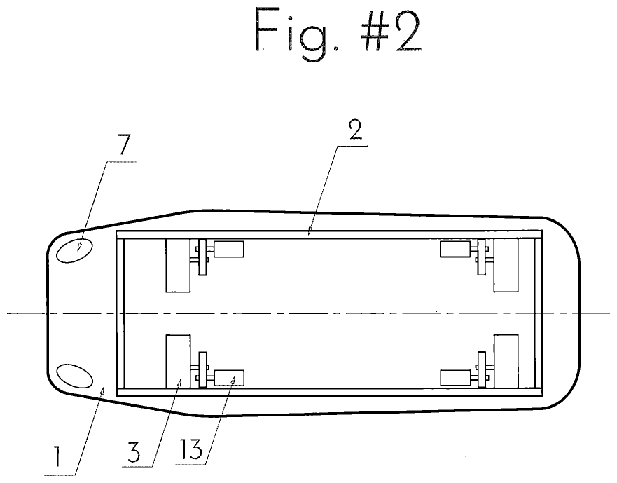

FIGS. 1 and 2 schematically illustrate top and side view for the vehicle, which in general includes the body 1, positioned on the chasses 2, and single to multiple power packs 3, providing uplift force, as well as directional capabilities.

Provided sketches show the vehicle equipped with four power packs 3. The body 4, in general provides seating, protection for passengers as well as housing for control panel, steering devices 5. Passengers cabin could be with O2 pressurization option for vehicles intended for higher altitudes.

Each power pack 3, is powered with independent electric motor/drive 6, mounted on the chasses and coupled with designated power pack.

Electric motors and all vehicle controls are powered by battery pack 7.

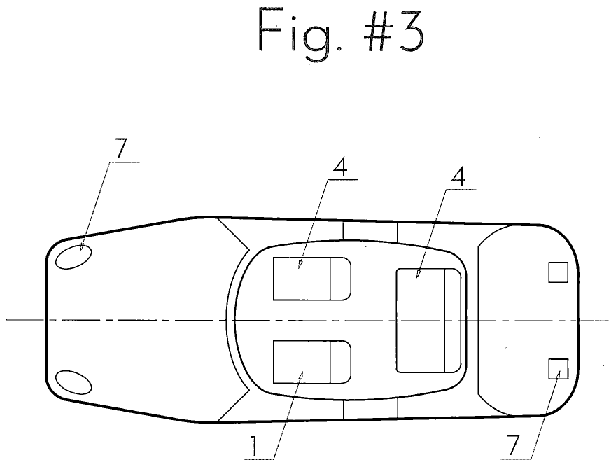

FIG. 3 schematically illustrates cabin interior arrangement.

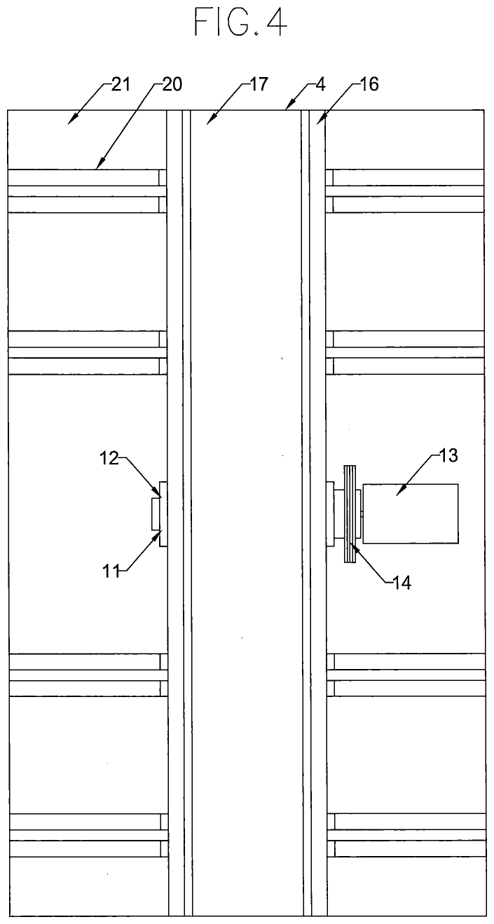

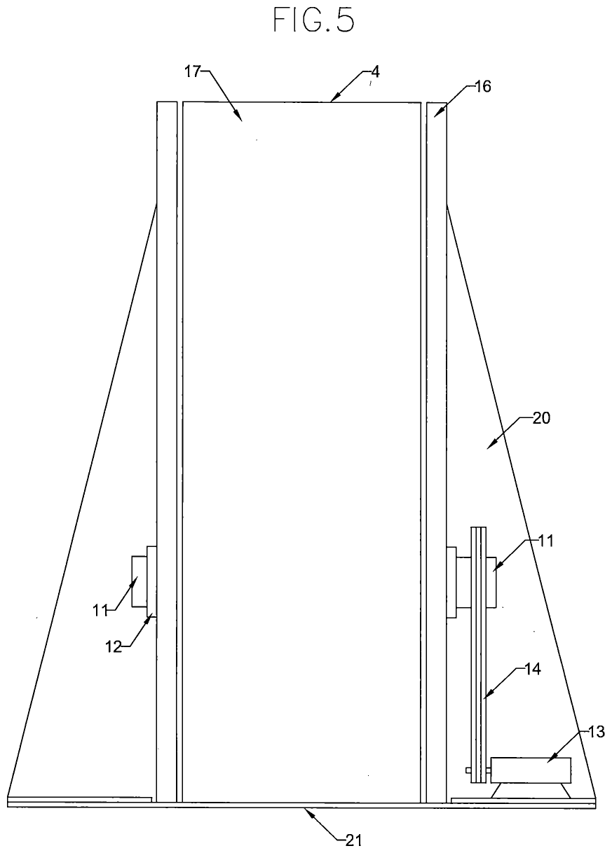

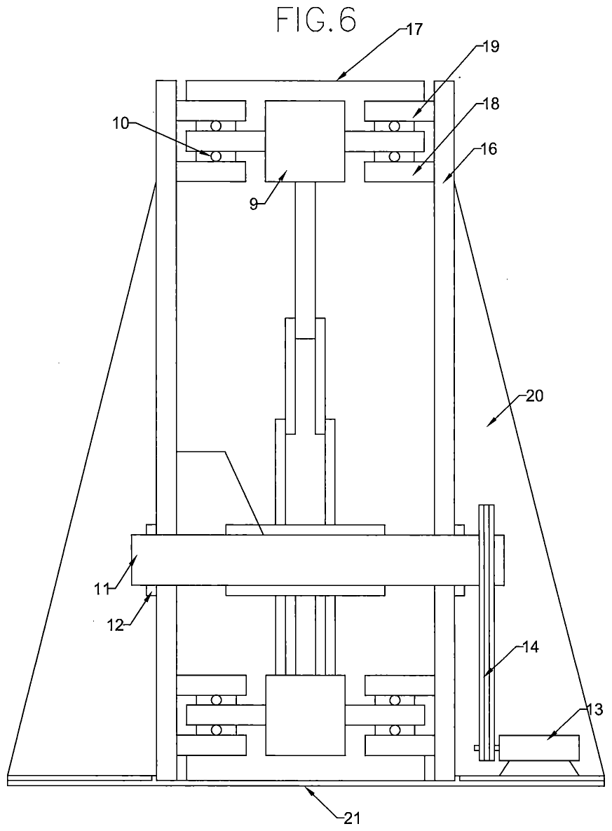

FIGS. 4, 5, 6 schematically illustrate centrifugal rotating power pack, consisted of multiple rotating arms 8, with weights at the ends rotating in elliptical pattern with axes of rotation eccentrically positioned to the horizontal center line of the housing, which consists of two housing enclosure half-casings bolted together. Each housing enclosure casing has a centrifugal groove imbedded into it to enable centrifugal rotation of weights at the end of arms.

Telescopically extendable arms 8 are attached to the hub 15.

Once arms start rotating centrifugal force would start increasing depending on RPM, transferring the force via bearings to the housing enclosure. Considering the elliptical movement, centrifugal force will be greater on upper section of the track, rather than on the lower that is closer to the axes of rotation.

Each arm is equipped with set of ball bearings 10, that enable rotation of arms along the housing tracks and at the same time transfer the forces from the arms to the housing enclosure.

Main shaft 11, connects all rotating arms together and is rested on two pillow block bearings attached to the housing.

The power from the electric motor is transmitted to the main shaft via belt/pulley assembly or chain/sprocket assembly 14.

Once certain RPM is reached, difference between centrifugal force on the upper part of the track and lower becomes grater than weight of the power pack/vehicle at which point sufficient uplifting force is created to overcome earth's gravity.

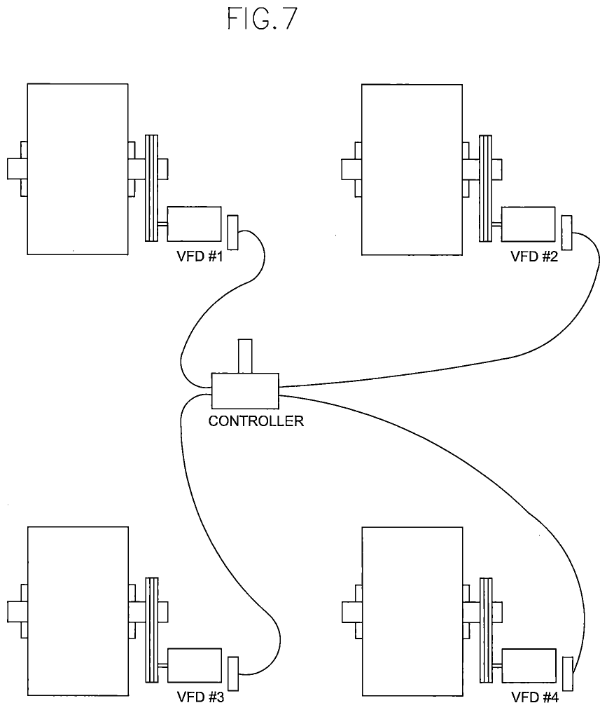

FIG. 7 shows simplified wiring control schematic individually supplying signal to each of the power packs from the control panel.
For vehicle up lift—gradually increase RPM on all four motors
For vehicle forward—gradually increase RPM on #3 and #4, reduce #2 and #1
For vehicle backward—gradually increase RPM on #1 and #2, reduce #3 and #4
For vehicle left turn—gradually increase #2 and #4
For vehicle right turn—gradually increase #1 and #3

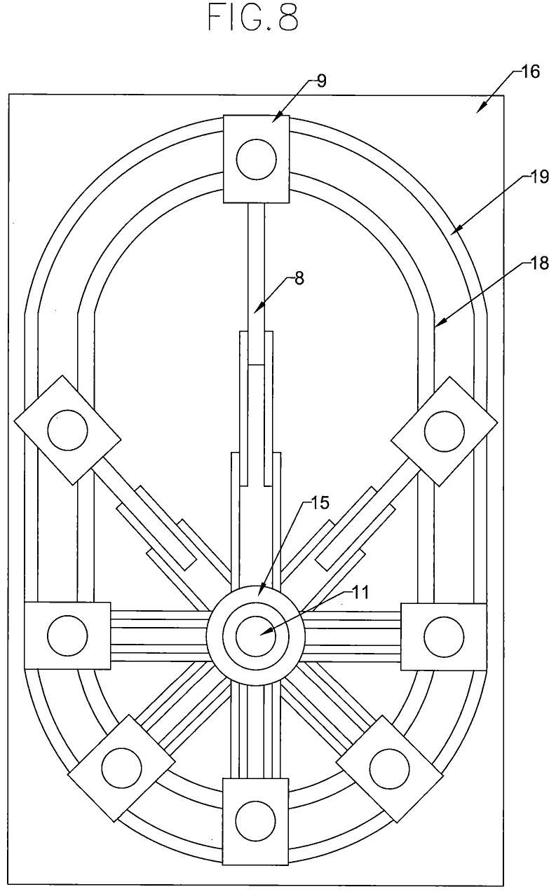

FIG. 8 shows other cross section of the power pack, perpendicular on section #6. Section shows oval path of the weights and off center shaft position, including extendable arms, shaft and hub.

1-7. (canceled)

8. A propulsion system for a flying vehicle, comprising:
a plurality of power packs mounted to a vehicle body, each power pack comprising:
a sealed housing enclosure;
an elliptical track fixed within the housing enclosure, the track having an upper portion farther from a central axis than a lower portion;
a rotatable shaft eccentrically positioned relative to the elliptical track;
a plurality of telescopically extendable arms connected to the rotatable shaft, each arm having a mass at its distal end configured to travel along the elliptical track; and
a variable-speed electric motor coupled to the rotatable shaft via a power transmission system; and
a control system configured to independently adjust rotation speed of each power pack to vary the movement direction of the vehicle;
wherein rotation of the extendable arms along the eccentric elliptical track generates a net upward force;
whereby synchronized adjustment of the rotation speed of all power packs causes the vehicle to ascend or descend without directional movement.

9. The propulsion system of claim 8, wherein the power transmission system comprises one of: a belt and pulley assembly, or a chain and sprocket assembly.

10. The propulsion system of claim 8, wherein the sealed housing enclosure comprises two half-casings bolted together.

11. The propulsion system of claim 8, wherein each power pack further comprises pillow block bearings supporting the rotatable shaft.

12. The propulsion system of claim 8, wherein the control system is configured to increase rotation speed of rear power packs relative to front power packs to propel the vehicle forward.

13. The propulsion system of claim 12, wherein the control system is further configured to increase rotation speed of power packs on one side of the vehicle relative to power packs on an opposite side to turn the vehicle.

14. The propulsion system of claim 8, further comprising a pressurized cabin within the vehicle body to enable operation at high altitudes.

15. A flying vehicle, comprising:
a body;
a plurality of power packs mounted to the body, each power pack comprising a housing enclosure containing an elliptical track and a rotatable shaft eccentrically positioned relative to the track;
a plurality of extendable arms connected to each rotatable shaft, each arm having a mass configured to travel along the elliptical track;
an electric motor coupled to each rotatable shaft; and
a control system configured to independently adjust rotation speed of each power pack;
wherein the eccentricity of the elliptical tracks generates a net upward force during rotation of the shafts.

16. The flying vehicle of claim 15, wherein the extendable arms are telescopically extendable.

17. The flying vehicle of claim 16, wherein each power pack further comprises pillow block bearings supporting the rotatable shaft.

18. The flying vehicle of claim 17, wherein the electric motor is coupled to the rotatable shaft via a power transmission system comprising one of: a belt and pulley assembly, or a chain and sprocket assembly.

19. The flying vehicle of claim 18, wherein the control system is configured to increase rotation speed of rear power packs relative to front power packs to propel the vehicle forward.

20. The flying vehicle of claim 19, wherein the control system is further configured to increase rotation speed of power packs on one side of the vehicle relative to power packs on an opposite side to turn the vehicle.

21. The flying vehicle of claim 20, further comprising a pressurized cabin within the vehicle body to enable operation at high altitudes.

22. A method of propelling a flying vehicle, comprising:
rotating a plurality of eccentrically-mounted shafts within separate housings, each shaft having multiple extendable arms with masses at their distal ends;
guiding the masses along elliptical tracks fixed within each housing, each track having an upper portion farther from the shaft's axis of rotation than a lower portion;
generating a net upward force due to the eccentricity of the elliptical tracks; and
independently controlling rotation speed of each shaft to maneuver the vehicle in three-dimensional space.

23. The method of claim 22, further comprising synchronizing extension and retraction of the telescopic arms with rotational position to enhance force generation.

24. The method of claim 22, further comprising:
mounting multiple power packs to a vehicle body, each power pack comprising a housing enclosure containing the rotatable shaft;
connecting a variable-speed electric motor to each rotatable shaft via a power transmission system; and
providing a control panel within the vehicle body for controlling the rotation speed of each power pack.

25. The method of claim 24, wherein independently controlling rotation speed of each shaft comprises adjusting rotation speed and direction of power packs on different sides of the vehicle to control pitch, roll, and yaw.

26. The method of claim 25, further comprising:
providing a pressurized cabin within the vehicle body to enable operation at high altitudes; and
incorporating signal lights at the front and rear corners of the vehicle body.

27. The method of claim 26, further comprising:
providing a watertight vehicle body;
constructing watertight power pack compartments within the vehicle body; and
incorporating a seating area in a central portion of the vehicle body.
